(19) United States
(12) Patent Application Publication
(10) Pub. No.: US 2025/0383316 A1
(43) Pub. Date: Dec. 18, 2025

(54) TEST STRIP WITH MULTIPLT ELECTROCHEMICAL REACTION BLOCKS

(71) Applicants: Yue Xu, Shanghai (CN); Yi Jou Lian, New Taipei City (TW); Yuan Chen Lee, New Taipei City (TW)

(72) Inventors: Yue Xu, Shanghai (CN); Yi Jou Lian, New Taipei City (TW); Yuan Chen Lee, New Taipei City (TW)

(21) Appl. No.: 18/743,633

(22) Filed: Jun. 14, 2024

(51) Int. Cl. G01N 27/327

(52) U.S. Cl. CPC G01N 27/3272

(57) ABSTRACT

A test strip with multiple electrochemical reaction blocks has multiple electrochemical reaction zone blocks but shares a sampling channel. However, it can suppress the structure of mediator diffusion and mutual interference in each reaction zone block. It includes plural detection electrodes, a first reaction zone and a second reaction zone. It uses the detection electrode in the first reaction zone to measure the hematocrit data of the analyte sample, at the same time, the detection electrode in the second reaction zone is used to read the reaction data generated by the analyte sample and the electrochemical mediator. These two data calculations for data compensation to correct the analyte concentration, avoiding measurement data deviation caused by the testing instrument due to different individual hematocrit ratios, and presenting the correct actual value of the analyte concentration.

### BACKGROUND OF THE INVENTION

### 1. Field of the Invention

The present invention relates to body fluid test strip technology and more particularly, to a test strip that has multiple electrochemical reaction blocks but shares a sampling channel, and can inhibit the diffusion of media substances in each reaction block from interfering with each other.

### 2. Description of the Related Art

Commonly used test strips, two objects to be tested are on the same channel. When the liquid specimen flows in, the electrochemical mediator in the front reaction zone will dissolve and then flow to the rear reaction zone. After the liquid sample fills each reaction zone, the electrochemical mediator in the rear reaction zone will diffuse to the front reaction zone, thus causing mutual interference in measurement.

Later, improved products came out. As shown in FIG. 7, the electrochemical mediator was applied to the two bifurcated channels, but the different media still flowed to other reaction zones when they were not dry. And when the liquid sample fills each reaction zone, the electrochemical mediators in both reaction zones will spread to the other reaction zones, still causing the problem of mutual interference in measurement.

In current analyte concentration testing, differences in hematocrit ratios interfere with the test results. For example, a high hematocrit ratio in infants will cause the measured blood sugar level to be too low, and a low hematocrit ratio in hemodialysis patients will cause the measured blood sugar level to be too high. The difference in this numerical range is also affected by age, gender, diet, physiology, etc.

Clinically, body fluids (such as blood) are measured using a large-scale biochemical testing machine in a clinical biochemistry laboratory. After centrifugation, the plasma is obtained and then tested to avoid the difference in hematocrit of whole blood from interfering with the test results. However, the use of such instruments must be in specific medical institutions, which limits the location of testing. For easy individual use, a handheld biosensor is combined with disposable body fluid test strips for whole blood sampling and testing. Due to individual differences in hematocrit ratio, the test data deviation problem occurs.

### SUMMARY OF THE INVENTION

In view of the problems existing in the prior art, the present invention provides a test strip with multiple electrochemical reaction blocks, which solves the problem in the prior art that when performing sample test, after the liquid sample fills each reaction zone of the test strip, the electrochemical mediators in each reaction zone will diffuse with each other and easily cause mutual interference in measurements.

The present invention provides a test strip with multiple electrochemical reaction blocks, which solves the problem in the prior art that when using a handheld biosensor with test strips to perform sample tests, it is easy to cause deviations in the test data.

In order to solve the above problems, some embodiments of a test strip with multiple electrochemical reaction blocks of the present invention comprises a substrate, a first spacer layer, a second spacer layer and a top cover layer. The substrate comprises a first conductor, a second conductor, and a third conductor. The first conductor, the second conductor and the third conductor are formed on the substrate in parallel and spaced apart from each other. One end of the first conductor is provided with a first contact electrode, and the other end of the first conductor is provided with a first detection electrode. The first conductor can be used as a hematocrit (Hct) detection conductor to measure the hematocrit (Hct). One end of the second conductor is provided with a second contact electrode, and the other end of the second conductor is provided with a second detection electrode. One end of the third conductor is provided with a third contact electrode, and the other end of the third conductor is provided with a third detection electrode. The first spacer layer comprises a first reaction zone and a second reaction zone located on one side in the form of a hollow respectively. The second spacer layer comprises a guide groove located on one side in the form of a hollow, and the guide groove has an inlet on one side. The second spacer layer is combined above the first spacer layer, and the guide groove is correspondingly connected to the first reaction zone and the second reaction zone.

The first spacer layer is combined on the upper side of the first conductor, the second conductor and the third conductor. The first detection electrode and the third detection electrode partially extend through the first reaction zone. The second detection electrode and the third detection electrode partially extend through the second reaction zone and are coated with at least one layer of first electrochemical mediator. The first reaction zone and the second reaction zone are not connected to each other.

The top cover layer comprises a first air hole and a second air hole. The top cover layer is combined with the second spacer layer. The first air hole is connected to the first reaction zone and the guide groove, and the second air hole is connected to the second reaction zone and the guide groove.

The lengths of the first spacer layer, second spacer layer and top cover layer are shorter than the substrate. The portions of the first contact electrode, the second contact electrode and the third contact electrode located on one side of the substrate are exposed portions.

The beneficial effects of the present invention are:

The invention has a plurality of electrochemical reaction zone blocks but shares a sampling channel, and at the same time can suppress the diffusion of mediators and mutual interference in each reaction zone block. Moreover, the present invention is used to compensate for the interference caused by the difference in analyte hematocrit ratio to the detection results. In addition, the test strip with multiple electrochemical reaction blocks in the present invention can provide a testing instrument to read the first reaction zone to obtain hematocrit (Hct) data, and the second reaction zone to obtain uncorrected analyte concentration. Then the deviation of the analyte concentration detection data is corrected according to the hematocrit ratio to present truly correct sample analysis concentration data. At the same time, one test strip in the present invention can detect multiple testing projects of the sample at the same time.

### BRIEF DESCRIPTION OF THE DRAWINGS

FIG. 1 is a schematic diagram of a first embodiment of the present invention.

FIG. 2 is an exploded view of the embodiment of FIG. 1 of the present invention.

FIG. 3 is a schematic diagram of a second embodiment of the present invention.

FIG. 4 is an exploded view of the embodiment of FIG. 3 of the present invention.

FIG. 5 is a schematic diagram of a third embodiment of the present invention.

FIG. 6 is an exploded view of the embodiment of FIG. 5 of the present invention.

FIG. 7 is an exploded view of a test strip according to the prior art.

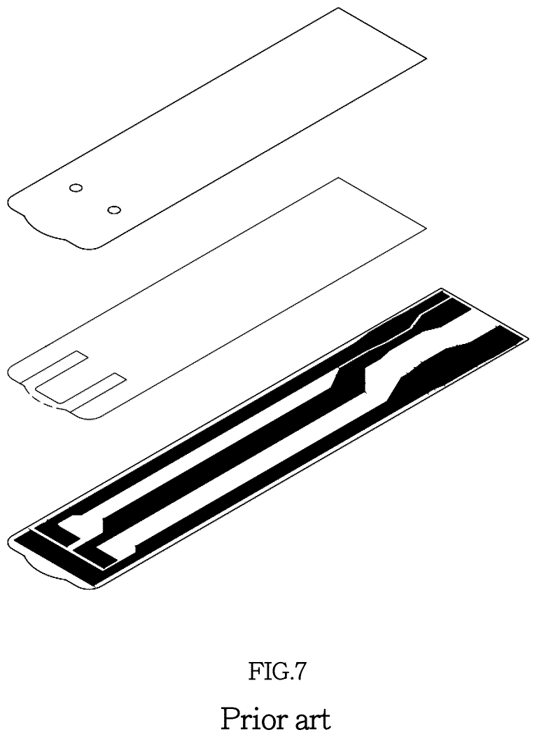

### DETAILED DESCRIPTION OF THE INVENTION

The preferred embodiments of the test strip with multiple electrochemical reaction blocks of the present invention are described in detail below with reference to the drawings.

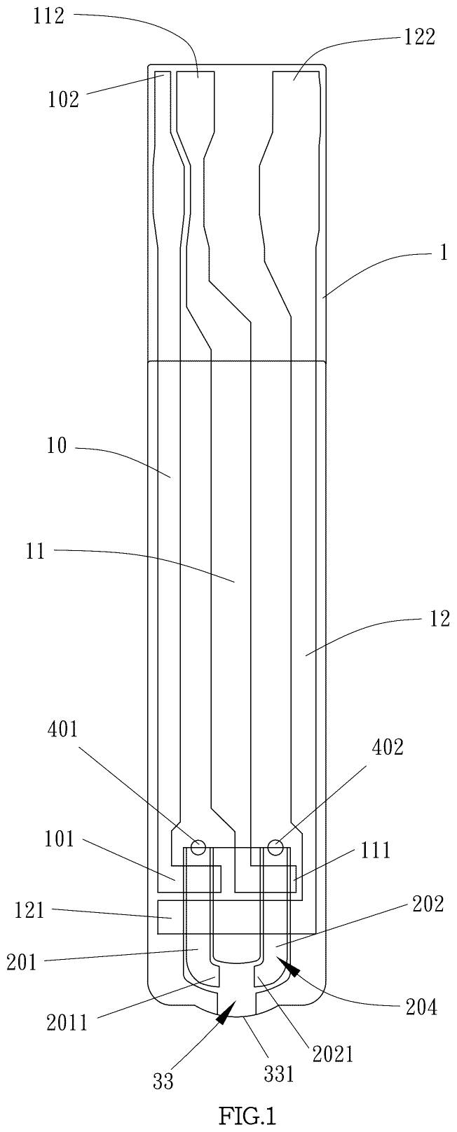

Please refer to FIGS. 1 to 3. A test strip with multiple electrochemical reaction blocks in accordance with a first embodiment of the present invention comprises: a substrate 1, a first spacer layer 20, a second spacer layer 30, and a top cover layer 40.

The substrate 1 is combined with a layer of conductive material such as carbon to form a plurality of transmission wires to define: a first conductor 10, a second conductor 11, and a third conductor 12. The first conductor 10, the second conductor 11 and the third conductor 12 are formed on the substrate 1 in parallel and spaced apart from each other.

One end of the first conductor 10 is provided with a first contact electrode 102, and the other end of the first conductor 10 is provided with a first detection electrode 101. One end of the second conductor 11 is provided with a second contact electrode 112, and the other end of the second conductor 11 is provided with a second detection electrode 111. One end of the third conductor 12 is provided with a third contact electrode 122, and the other end of the third conductor 12 is provided with a third detection electrode 121.

The first contact electrode 102, the second contact electrode 112 and the third contact electrode 122 are used to electrically connect a testing instrument (such as blood glucose monitor).

In the embodiment, the first conductor 10 is used as a hematocrit (hematocrit) detection conductor to measure the hematocrit (Hct). The first conductor 10 is, for example, an AC potential signal conductor. The second conductor 11 and the third conductor 12 are, for example, DC potential signal conductors, and the second conductor 11 can be used as a conductor for detecting a first analyte, such as blood glucose concentration.

The first spacer layer 20 comprises a first reaction zone 201 and a second reaction zone 202 located on one side in the form of a hollow respectively. The first reaction zone 201 and the second reaction zone 202 defined by the respective hollows are not connected to each other in the embodiment.

The second spacer layer 30 comprises a guide groove 31 located on one side in the form of a hollow, and the guide groove 31 has an inlet 33 on one side. The second spacer layer 30 is combined above the first spacer layer 20, and the guide groove 31 corresponds to the first reaction zone 201 and the second reaction zone 202.

The first spacer layer 20 is combined on the upper side of the first conductor 10, the second conductor 11 and the third conductor 12. The first detection electrode 101 and the third detection electrode 121 partially extend through the first reaction zone 201. In the embodiment, the first conductor 10 serves as an AC potential signal conductor, and the first detection electrode 101 inside the first reaction zone 201 and the third detection electrode 121 of the third conductor 12 are used as hematocrit (Hct) detection points to measure the hematocrit (Hct). The first reaction zone 201 does not need to be coated with electrochemical mediator. The second detection electrode 111 and the third detection electrode 121 partially extend through the second reaction zone 202 and are coated with at least one layer of first electrochemical mediator 51 (such as various reaction reagents such as enzymes or electronic mediators, etc.) for detecting the concentration of a first analyte (such as blood sugar). The first reaction zone 201 and the second reaction zone 202 are not connected to each other. The first detection electrode 101 and second detection electrode 111 are used as working electrodes, and the third detection electrode 121 is used as a reference electrode. The design area of the reaction zone of the present invention can be reduced, and various enzyme reaction reagents combined with the electrochemical mediator corresponding to the detection electrode and the reference electrode coated on the upper side of the substrate 1 can control the appropriate amount, not too much, so that the biological response data of the sample can be more accurate.

The top cover layer 40 comprises a first air hole 401 and a second air hole 402. The top cover layer 40 is combined with the second spacer layer 30. The first air hole 401 is connected to the first reaction zone 201 and the guide groove 31, and the second air hole 402 is connected to the second reaction zone 202 and the guide groove 31 to form an exhaust channel function. The first air hole 401 can thereby produce a capillary siphon effect on the first reaction zone 201, the guide groove 31 and the inlet 33, and the second air hole 402 can produce a capillary siphon effect on the second reaction zone 202, the guide groove 31 and the inlet 33.

The first spacer layer 20, the second spacer layer 30 and the top cover layer 40 are shorter than the substrate 1. The portions of the first contact electrode 102, the second contact electrode 112 and the third contact electrode 122 located on one side of the substrate are exposed portions for electrically connecting to a testing instrument (such as blood glucose monitor).

Thereby, the stacked thickness of the substrate 1, the first spacer layer 20 and its first reaction zone 201 and second reaction zone 202, the second spacer layer 30 and its guide groove 31, and the top cover layer 40 forms a siphon diversion channel from inlet 33. The test strip of the present invention has multiple electrochemical reaction zones but share a sampling channel, and can suppress mediator diffusion and mutual interference in each reaction zone. The sample can be injected into the first reaction zone 201 and the second reaction zone 202 through this channel to contact the detection electrodes.

When performing detection, for example, analyzing blood glucose concentration in the embodiment, the first conductor 10 is a hematocrit (Hct) detection conductor for measuring the hematocrit (Hct). In one embodiment, the first conductor 10 is, for example, an AC potential signal conductor, and the second conductor 11 and the third conductor 12 are, for example, a DC potential signal conductor.

The first detection electrode 101 of the first conductor 10 of the AC potential signal and the third detection electrode 121 of the third conductor 12 in the inner side of the first reaction zone 201 are used as hematocrit detection points to measure the hematocrit.

The second detection electrode 111 and the third detection electrode 121 inside the second reaction zone 202 are coated with at least one layer of the first electrochemical mediator 51 of designated test items according to different sample items (such as various reaction reagents such as special enzymes for blood glucose detection).

Test sample such as blood, each individual blood has different hematocrit. The user uses the inlet 33 side of the test strip with multiple electrochemical reaction blocks of the present invention to contact and collect the blood. Through the exhaust function of the first air hole 401 and the second air hole 402, it can be quickly and effectively capillary siphoned from the inlet 33 of the test strip with multiple electrochemical reaction blocks into the guide groove 31 and the hematocrit detection points formed inside the first reaction zone 201, and contacts the first detection electrode 101 of the AC potential signal conductor and the third detection electrode 121 to measure the hematocrit. It can avoid the diffusion of blood glucose electrochemical mediator enzymes from another reaction zone, so an accurate hematocrit can be obtained. And the blood of the specimen is capillary siphoned into the second reaction zone 202 and contacts the first electrochemical mediator 51 and the second detection electrode 111 and the third detection electrode 121 to produce an oxidation-reduction reaction to generate an electronic signal. The above-mentioned multiple electrochemical reaction zones share a sampling channel, which can inhibit the diffusion of mediators in each reaction zone from interfering with each other.

Thereby, the test strip with multiple electrochemical reaction blocks is inserted into a testing instrument (such as a blood glucose monitor), and the first contact electrode 102, the second contact electrode 112 and the third contact electrode 122 are electrically connected to the testing instrument (such as a blood glucose monitor) to generate corresponding electrical reactions to measure blood. For example, by reading the AC potential signal of the blood sample in the first reaction zone 201 through the first conductor 10 of the AC potential signal, blood samples with different hematocrit ratios can be measured. The measured hematocrit ratio is determined by the testing instrument (such as a blood glucose monitor) to read the measurement data. And at the same time, the blood sample (such as blood glucose) in the second reaction zone 202 is read, and after contacting the special enzyme of the first electrochemical mediator 51, an oxidation-reduction reaction occurs, and a DC potential signal is generated to monitor changes in its current value or resistance value for detection. The measurement value is compensated by the hematocrit correction. By measuring the data difference of different hematocrits, it serves as the basis for the calibration of the analyte concentration of the testing instrument. The two data are used for data compensation to present a truly correct value (value/L Data), so that the testing instrument, such as a blood glucose monitor, can obtain the final corrected actual value (correct value) such as blood glucose concentration after calibration. In other embodiments, those with ordinary knowledge in the art will understand that, for example, when using circuit mechanisms with different designs, the detection method may include other changes, such as measuring current, capacitance, voltage, resistance or other electrical forms, but the invention is not limited thereto.

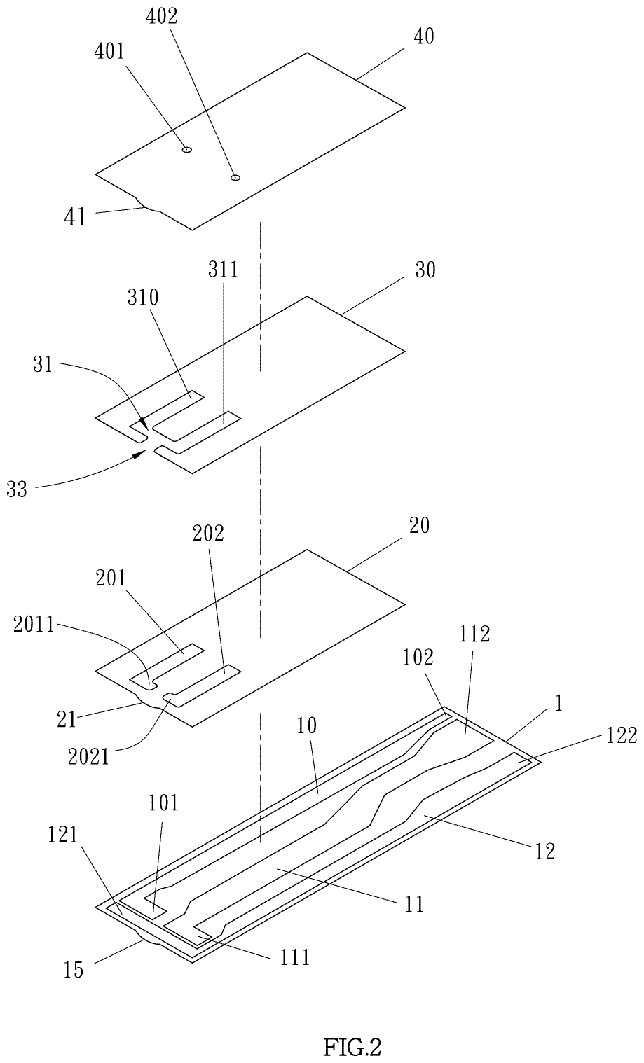

Please refer to FIG. 1 and FIG. 2, an embodiment of the test strip with multiple electrochemical reaction blocks of the present invention, wherein the shape of the guide groove 31 corresponds to the first reaction zone 201 and the second reaction zone 202, The guide groove 31 extends from one side of the inlet 33 to form a first groove 310 and extends from the other side of the inlet 33 to form a second groove 311. The first groove 310 is connected to the first reaction zone 201, and the second groove 311 is connected to the second reaction zone 202. The first groove 310 and the second groove 311 are connected to each other through the inlet 33. The first air hole 401 is correspondingly connected to the first groove 310 and the first reaction zone 201. The second air hole 402 is correspondingly connected to the second groove 311 and the second reaction zone 202. The foregoing configuration may include other changes, which can be understood by those with ordinary knowledge in the art. For example, the first groove 310 and the second groove 311 are respectively connected to different inlets and use different connection channels. The present invention is not limited thereto.

Please refer to FIG. 1 and FIG. 2, in an embodiment of the test strip with multiple electrochemical reaction blocks of the present invention, the first reaction zone 201 forms a first extension section 2011 toward one side of the inlet 33, and the second reaction zone 202 forms a second extension section 2021 toward one side of the inlet 33. Thereby, the first reaction zone 201 and the second reaction zone 202 can be closer to the inlet 33, so that a small amount of sample can be siphoned into the first reaction zone 201 and the second reaction zone 202 more quickly and efficiently.

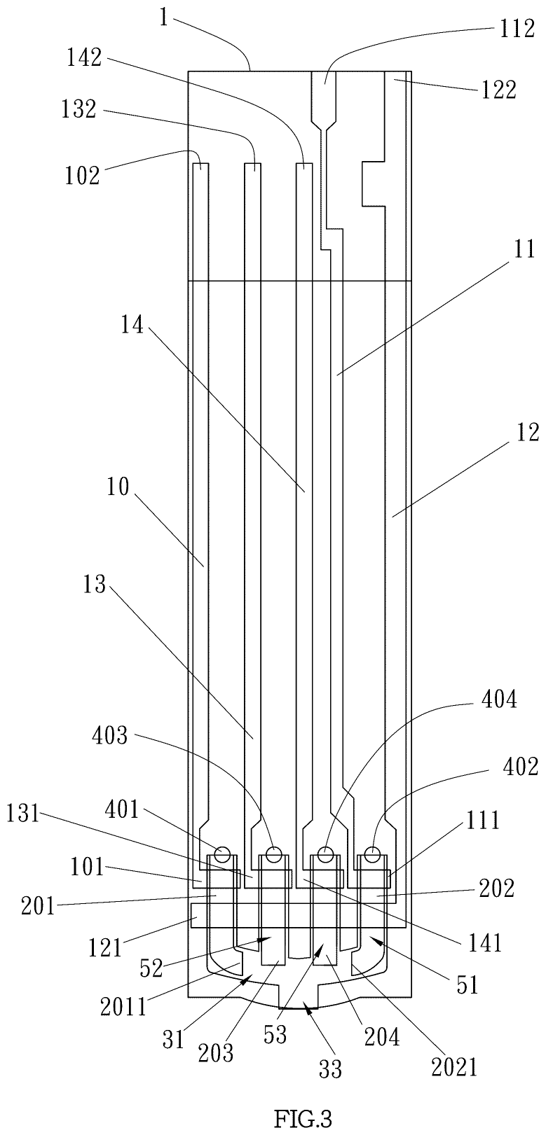

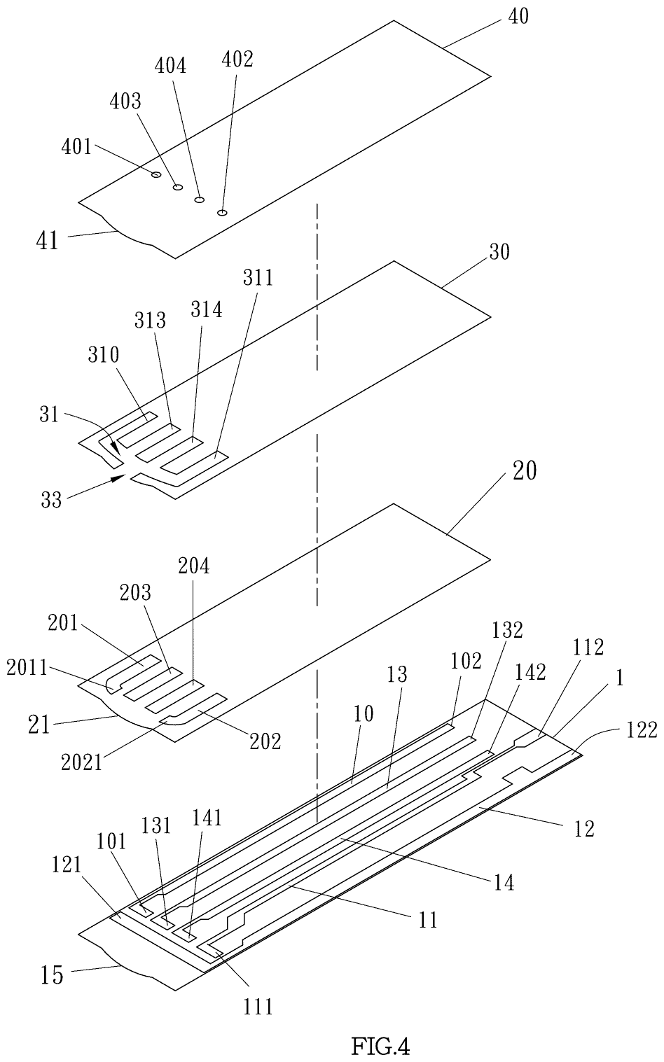

Please refer to FIGS. 3 and 4. Some embodiments of the test strip with multiple electrochemical reaction blocks of the present invention are the same as the previous embodiments. In addition to the hematocrit detection electrode in the first reaction zone 201, some examples of expanded applications of this embodiment may include multiple independent reaction zones. For example, there are three independent reaction zones, each coated with an electrochemical mediator such as total cholesterol, triglyceride, and high-density cholesterol, to measure the values of different test items of a sample (analyte). The testing instrument can calculate Low-density cholesterol using a formula. The test strip with multiple electrochemical reaction blocks, wherein the first detection electrode of the AC potential signal and the third detection electrode inside the first reaction zone are used as hematocrit detection points. The test strip also comprises a plurality of independent reaction zones, which are coated with different electrochemical mediators to measure the values of different test items of a sample (analyte).

The substrate 1 further comprises a fourth conductor 13 and a fifth conductor 14, which are formed on the substrate 1 at intervals parallel to the first conductor 10, the second conductor 11 and the third conductor 12. The fourth conductor 13 and the fifth conductor 14 are, for example, DC circuit conductors. A fourth contact electrode 132 is provided at one end of the fourth conductor 13, and a fourth detection electrode 131 is provided at the other end of the fourth conductor 13. One end of the fifth conductor 14 is provided with a fifth contact electrode 142, and the other end of the fifth conductor 14 is provided with a fifth detection electrode 141. The first conductor may be an AC potential signal conductor, the second conductor, the third conductor, the fourth conductor or/and the fifth conductor may be DC circuit conductors.

The first spacer layer 20 further comprises a third reaction zone 203 and a fourth reaction zone 204 located on one side in the form of a hollow respectively, and are arranged in parallel between the first reaction zone 201 and the second reaction zone 202. The fourth detection electrode 131 and the third detection electrode 121 extend through the third reaction zone 203 and are coated with at least one layer of second electrochemical mediator 52 (such as total cholesterol reaction reagent, etc.). The fifth detection electrode 141 and the third detection electrode 121 extend through the fourth reaction zone 204 and are coated with at least one layer of third electrochemical mediator 53 (such as high-density cholesterol reaction reagent, etc.). And the second detection electrode 111 inside the second reaction zone 202 and the third detection electrode 121 are coated with at least one layer of first electrochemical mediator 51 (triglyceride). The third reaction zone 203, the fourth reaction zone 204, the first reaction zone 201 and the second reaction zone 202 are not connected to each other.

The guide groove 31 of the second spacer layer 30 further comprises a third groove 313 and a fourth groove 314, which are formed between the first groove 310 and the second groove 311. The third groove 313 and the fourth groove 314 are connected with the inlet 33, the first groove 310 and the second groove 311 respectively. The second spacer layer 30 is combined above the first spacer layer 20. The first groove 310 is correspondingly connected to the first reaction zone 20, the second groove 311 is correspondingly connected to the second reaction zone 202, the third groove 313 is correspondingly connected to the third reaction zone 203, and the fourth groove 314 is correspondingly connected to the fourth on reaction zone 204. In this way, trace amounts of body fluid samples can be easily introduced into each reaction zone through the corresponding siphons of each groove to improve detection accuracy.

The top cover layer 40 further comprises a third air hole 403 and a fourth air hole 404. The top cover layer 40 is combined with the second spacer layer 30. The first air hole 401 is correspondingly connected to the first reaction zone 201 and the first groove 310, the second air hole 402 is correspondingly connected to the second reaction zone 202 and the second groove 311, and the third air hole 403 is correspondingly connected to the third reaction zone 203 and the third groove 313, and the fourth air hole 404 is correspondingly connected to the fourth reaction zone 204 and the third groove 314. The portions of the fourth contact electrode 131 and the fifth contact electrode 142 located on one side of the substrate 1 are exposed portions.

Thereby, the stacked thickness of the substrate 1, the first spacer layer 20 and its first reaction zone 201, second reaction zone 202, third reaction zone 203 and fourth reaction zone 204, the second spacer layer 30 and its guide groove 31 and the top cover layer 40 forms a channel from the inlet 33 for sample siphon diversion. The sample (can be injected through this channel to contact the detection electrodes in the first reaction zone 201, second reaction zone 202, third reaction zone 203 and fourth reaction zone 204, the first electrochemical mediator 51 (such as triglyceride) and the second electrochemical mediator 52 (such as total cholesterol reaction reagent, etc.). The above-mentioned multiple electrochemical reaction zones share a sampling channel, but can inhibit the diffusion of mediators in each reaction zone from interfering with each other.

The portions of the first contact electrode 102, the second contact electrode 112, the third contact electrode 122 and the fourth contact electrode 131 located on one side of the substrate 1 are exposed portions for electrically connecting to a testing instrument (such as blood glucose monitor). This is used to measure different values separately. The hematocrit data measured by the detection electrode in the first reaction zone 201 and the measurement data of the second reaction zone 202, third reaction zone 203 and fourth reaction zone 204 are provided, so that the testing instrument can calculate low-density cholesterol using a formula to implement another testing project.

In some embodiments of the test strip with multiple electrochemical reaction blocks of the present invention, the first groove 310 to the fourth groove 314 or/and the first reaction zone 201 to the fourth reaction zone 204 include, for example, a rectangle, a square, a circle, an ellipse, a polygon, or any kind of irregular shape.

The test strip with multiple electrochemical reaction blocks of the present invention can provide a testing instrument (such as a blood glucose monitor) to directly read the hematocrit ratio data of the sample, as well as the reaction data generated by the sample and electrochemical mediator (reaction reagent). The two types of data are used for data compensation to correct the analyte concentration (such as blood sugar), to avoid the problem of incompletely accurate detection data caused by the hematocrit deviation of different individuals, and to present the correct actual value of the analyte concentration.

Wherein, the first reaction zone 201, the second reaction zone 202, the third reaction zone 203 and the fourth reaction zone 204 are not connected to each other. The design area of the reaction zone of the present invention can be reduced, and various enzyme reaction reagents combined with the electrochemical mediator coated on the detection electrodes on the upper side of the substrate 1 can control the appropriate amount, not too much, so that the biological response data of the sample can be more accurate. Because the present invention avoids mediator diffusion interference, the instrument can obtain accurate total cholesterol, triglyceride, and high-density cholesterol values, and the testing instrument calculates accurate low-density cholesterol values using formulas.

In some other embodiments, those with ordinary knowledge in the art will understand that, for example, using more working conductors and other circuit mechanisms with different designs, the detected liquid analysis concentration items can be increased, for example, any of high-density cholesterol HDLC, heme HI, triglyceride TG, ketone body, and UA. The test strip with multiple electrochemical reaction blocks of the present invention can enable the testing instrument to detect multiple items at the same time, thereby shortening the detection time and improving the detection efficiency.

In some embodiments of the test strip with multiple electrochemical reaction blocks of the present invention, the front end of the inlet 33 may have a protruding, concave or flat structure. The shape of the upper and lower sides of the front end of the inlet 33 is, for example, a flat, protruding or concave structure, to assist the inlet 33 to more effectively contact and guide the collected sample.

Please refer to FIGS. 1 to 4, in some embodiments, the shape of the upper and lower sides of the front end of the inlet 33 is a protruding structure 331, and the substrate 1 forms a first sampling flange 15 on one side corresponding to the inlet 33. The first spacer layer 20 forms a second sampling flange 21 on one side corresponding to the inlet 33. The top cover layer 40 forms a third sampling flange 41 on one side corresponding to the inlet 33. Thereby, the upper and lower sides of the front end of inlet 33 of the test strip with multiple electrochemical reaction blocks is formed into a protruding structure 331. During sampling, the third sampling flange 41 forming a protruding point is on the upper side of the inlet 33, and the first sampling flange 15 and the second sampling flange 21 are stacked on the lower side of the inlet 33 to accurately and quickly assist the test strip in contact with a small amount of the sample for sampling. A small amount of sample is accurately delivered to the inlet 33 and capillary siphoned into the guide groove 31 and then the sample enters the first reaction zone 201 or the second reaction zone 202 or the third reaction zone 203, and the sample is fully sampled quickly and effectively for producing correct detection data.

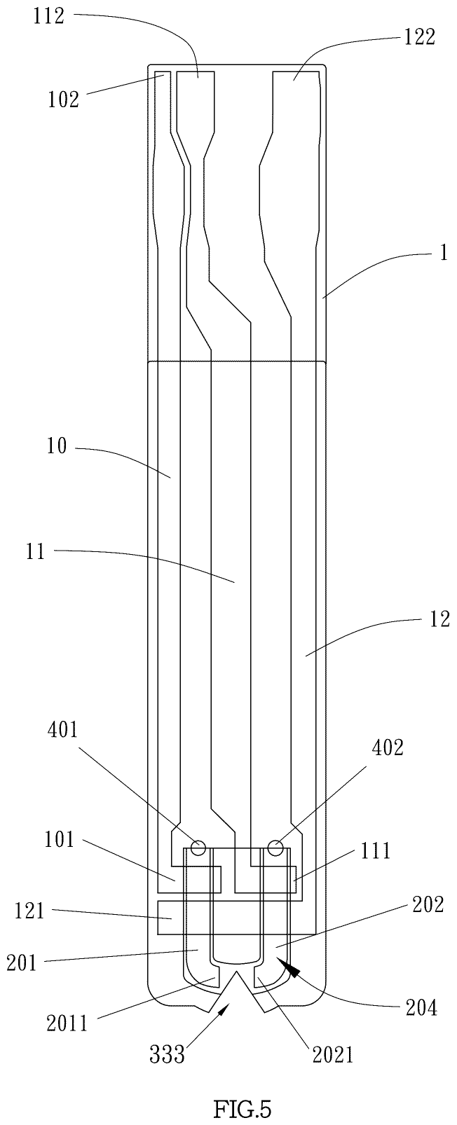

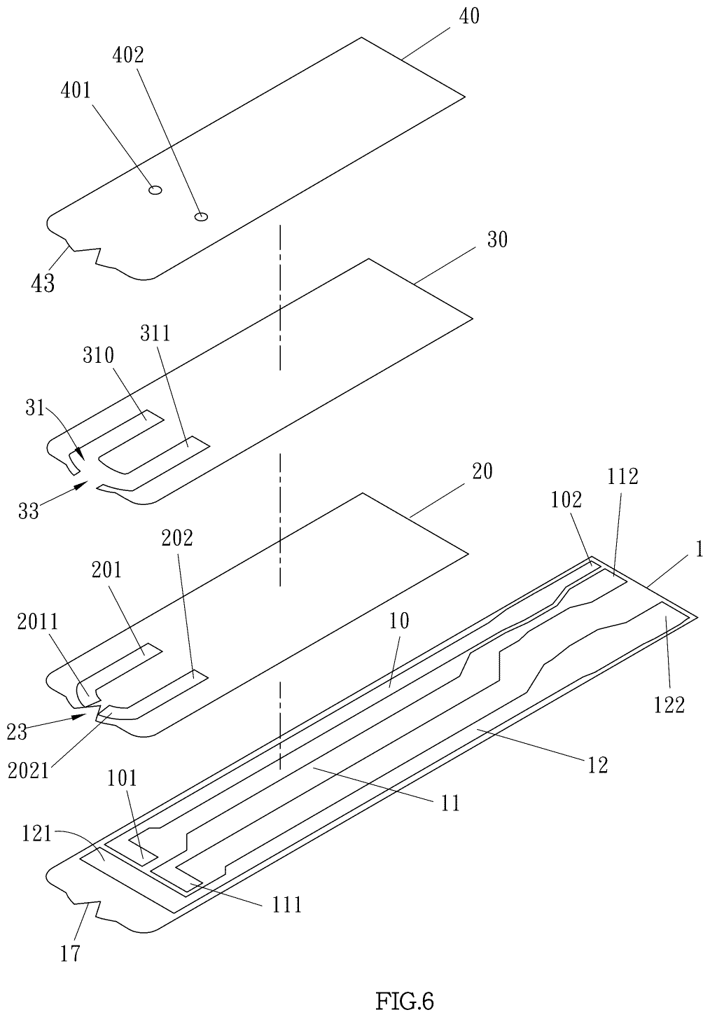

Please refer to FIGS. 5 to 6, in one embodiment of test strip with multiple electrochemical reaction blocks of the present invention, the shape of the upper and lower sides of the front end of the inlet 33 is a concave structure 333. The substrate 1 forms a first V-shaped sampling port 17 on one side corresponding to the inlet 33. The first spacer layer 20 forms a second V-shaped sampling port 23 on one side corresponding to the inlet 33. The top cover layer 40 forms a third V-shaped sampling port 43 on one side corresponding to the inlet 33. Thereby, the upper and lower sides of the front end of inlet 33 of the test strip with multiple electrochemical reaction blocks is formed into a concave structure 333. During sampling, the third V-shaped sampling port 43 forming a concave point is on the upper side of the inlet 33, and the first V-shaped sampling port 17 and the second V-shaped sampling port 23 are stacked on the lower side of the inlet 33. The front end of the inlet 33 of the test strip with multiple electrochemical reaction blocks is formed into a protruding structure 331, which is used to accurately and quickly assist the detection test strip in contact with a small amount of the sample for sampling. A small amount of sample is accurately delivered to the inlet 33 and capillary siphoned into the guide groove 31 and then the sample enters the first reaction zone 201 or the second reaction zone 202 and the third reaction zone 203. The concave-shaped structure can include any of U-shaped, V-shaped or rectangular. Those with ordinary knowledge in the field can understand and use these structures to quickly and effectively sample the sample to provide the testing instrument with accurate data detection.

In some application examples of the present invention, in electrochemical test strips, the hematocrit HCT is converted using the AC measurement value, and the DC part is then compensated accordingly with the calculated HCT value.

Please refer to TABLE A for the conventional test strip. When the real HCT=60, for example, the AC values are (7828, 8503, 8364). Therefore, the measured HCT is converted to (52, 65, 62). The correct compensation amount for the DC part should be based on HCT=60. However, since the HCT is measured to be (52, 65, 62), the DC part compensation amount is based on HCT=(52, 65, 62), which is quite different from the expected correct value. The same results are obtained when HCT is other values. The reference examples of deviation values without data compensation for data obtained from prior art test strips are shown in Table A below.

TABLE A

| | HCT20 | | HCT40 | | HCT60 | |
|---|---|---|---|---|---|---|
| | DC | AC | DC | AC | DC | AC |
| 100 mg/dL | 207 | 4671 | 71 | 5119 | 69 | 7821 |
| 250 mg/dL | 555 | 4482 | 284 | 5452 | 86 | 8503 |
| 400 mg/dL | 942 | 4408 | 589 | 5466 | 291 | 8364 |

TABLE B is a detection example of the test strip with multiple electrochemical reaction blocks of the present invention. For example, when the real HCT is 60, the AC values are (1520, 1522, 1523, 1528). Therefore, the measured HCT is converted to (59.5, 60, 60, 61). The DC part compensation amount is based on HCT= (59.5, 60, 60, 61). The result is close to the compensation amount required for HCT=60. The compensation amount has only a very small error compared with HCT=60. The same results are obtained when HCT is other values. The reference examples of the more accurate value of the data obtained from the test strips of the present invention after data compensation are shown in Table B below.

TABLE B

| | | HCT0 | | HCT20 | | HCT40 | | HCT60 | |
|---|---|---|---|---|---|---|---|---|---|
| | | DC | AC | DC | AC | DC | AC | DC | AC |
| 40 | mg/dL | 229 | 3370 | 203 | 2850 | 172 | 2220 | 164 | 1520 |
| 100 | mg/dL | 387 | 3375 | 360 | 2830 | 305 | 2225 | 259 | 1522 |
| 200 | mg/dL | 716 | 3370 | 624 | 2860 | 527 | 2223 | 418 | 1523 |
| 400 | mg/dL | 1374 | 3372 | 1150 | 2840 | 970 | 2221 | 634 | 1528 |

In some embodiments of the present invention, the substrate or spacer layer is, for example, an insulating material selected from one or a mixture of two or more materials selected from polyamide, polyester, polycarbonate, polyethylene terephthalate or polyvinyl chloride.

The materials of these circuit conductors are selected from one or a mixture of two or more materials with good electrical conductivity including gold, silver, palladium, platinum, carbon, biocarbon, silver glue, silver/silver chloride glue. When the carbon and biocarbon are used, for example, screen printing is employed to print carbon ink on a substrate to form circuit conductors. Or the above-mentioned metal material, such as silver glue, is coated on a substrate, and then laser engraving is used to form a plurality of conductors at intervals. The material and the method of forming the test strip are not limited to this.

What is claimed is:

1. A test strip with multiple electrochemical reaction blocks, comprising:
a substrate, said substrate comprising a first conductor, a second conductor and a third conductor formed on said substrate in parallel and spaced apart from each other, said first conductor comprising a first contact electrode located on one end thereof and a first detection electrode located on an opposite end thereof, said second conductor comprising a second contact electrode located on one end thereof and a second detection electrode located on an opposite end thereof, said third conductor comprising a third contact electrode located on one end thereof and a third detection electrode located on an opposite end thereof, said second detection electrode and said third detection electrode being coated with at layer of first electrochemical mediator, said first contact electrode, said second contact electrode and said third contact electrode each having a part thereof located om one side of said substrate and exposed to the outside;
a first spacer layer, said first spacer layer comprising a first reaction zone and a second reaction zone located on one side thereof in the form of a hollow respectively and spaced apart from each other, said first reaction zone being configured for said first detection electrode and said third detection electrode to partially extend through said first reaction zone, said first reaction zone being configured for said second detection electrode and said third detection electrode to partially extend through said second reaction zone, said first spacer layer being combined with said first conductor, said second conductor and said third conductor;
a second spacer layer, said second spacer layer comprising a guide groove located on one side thereof in the form of a hollow, said guide groove comprising an inlet located on one side thereof, said second spacer layer being combined above said first spacer layer, and said guide groove being connected to said first reaction zone and said second reaction zone; and
a top cover layer, said top cover layer comprising a first air hole and a second air hole, said top cover layer being combined with said second spacer layer, said first air hole being correspondingly connected to said first reaction zone and said guide groove, and said second air hole being correspondingly connected to said second reaction zone and said guide groove.

2. The test strip with multiple electrochemical reaction blocks as claimed in claim 1, wherein the shape of said guide groove corresponds to said first reaction zone and said second reaction zone; said guide groove comprises a first groove extending from one side of said inlet and a second groove extending from an opposite side of said inlet, said first groove being correspondingly connected to said first reaction zone, said second groove being correspondingly connected to said second reaction zone; said first air hole is correspondingly connected to said first groove and said first reaction zone; said second air hole is correspondingly connected to said second groove and said second reaction zone.

3. The test strip with multiple electrochemical reaction blocks as claimed in claim 2, wherein:
said substrate further comprises a fourth conductor and a fifth conductor, which are formed on said substrate at intervals parallel to said first conductor, said second conductor and said third conductor, said fourth conductor comprising a fourth contact electrode located om one end thereof and a fourth detection electrode located on an opposite end thereof, said fifth conductor comprising a fifth contact electrode located om one end thereof and a fifth detection electrode located on an opposite end thereof;
said first spacer layer further comprises a third reaction zone and a fourth reaction zone located on one side in the form of a hollow respectively, and are arranged in parallel between said first reaction zone and said second reaction zone, said fourth detection electrode and said third detection electrode extending through said third reaction zone and coated with at layer of second electrochemical mediator, said fifth detection electrode and said third detection electrode extending through said fourth reaction zone and coated with a layer of third electrochemical mediator, said third reaction zone, said fourth reaction zone, said first reaction zone and said second reaction zone being spaced apart from each other;
said guide groove of said second spacer layer further comprises a third groove and a fourth groove, said third groove and said fourth groove being formed between said first groove and said second groove, said third groove and said fourth groove being connected with said inlet, said first groove and said second groove respectively, said third groove being correspondingly connected to said third reaction zone, said fourth groove being correspondingly connected to said fourth on reaction zone;
said top cover layer further comprises a third air hole and a fourth air hole, said third air hole being correspondingly connected to said third reaction zone and said third groove, and said fourth air hole being correspondingly connected to said fourth reaction zone and said third groove;
said fourth contact electrode and said fifth contact electrode each have a part thereof located on one side of said substrate side and exposed to the outside.

4. The test strip with multiple electrochemical reaction blocks as claimed in claim 3, wherein said first groove, said second groove, said third groove and said fourth groove or/and said first reaction zone, said second reaction zone, said third reaction zone and said fourth reaction zone are either rectangular or polygonal.

5. The test strip with multiple electrochemical reaction blocks as claimed in claim 1, wherein said first reaction zone forms a first extension section toward one side of said inlet, and said second reaction zone forms a second extension section toward one side of said inlet.

6. The test strip with multiple electrochemical reaction blocks as claimed in claim 1, wherein said inlet has a front end thereof selectively configured in a protruding shape, a flat shape or a concave structure.

7. The test strip with multiple electrochemical reaction blocks as claimed in claim 6, wherein said second spacer layer forms a protruding structure on upper and lower sides of a front end of said inlet; said substrate forms a first sampling flange on one side corresponding to said inlet; said first spacer layer forms a second sampling flange on one side corresponding to said inlet; said top cover layer forms a third sampling flange on one side corresponding to said inlet; said first sampling flange and said second sampling flange are stacked on a lower side of said inlet, and said third sampling flange is on an opposing upper side of said inlet.

8. The test strip with multiple electrochemical reaction blocks as claimed in claim 6, wherein said second spacer layer forms a concave structure on a front end of said inlet; said substrate forms a first V-shaped sampling port on one side corresponding to said inlet; said first spacer layer forms a second V-shaped sampling port on one side corresponding to said inlet; said top cover layer forms a third V-shaped sampling port on one side corresponding to said inlet; said first V-shaped sampling port and said second V-shaped sampling port are stacked on a lower side of said inlet, and said third V-shaped sampling port is on an opposing upper side of said inlet.

9. The test strip with multiple electrochemical reaction blocks as claimed in claim 3, wherein said first conductor is an AC potential signal conductor; said second conductor, said third conductor, said fourth conductor or/and said fifth conductor are DC circuit conductors; said first detection electrode and said third detection electrode of the AC potential signal inside said first reaction zone are used as hematocrit detection points.

10. The test strip with multiple electrochemical reaction blocks as claimed in claim 9, wherein said first detection electrode and said third detection electrode of the AC potential signal inside said first reaction zone are used as the hematocrit detection points; the test strip with multiple electrochemical reaction blocks further comprises a plurality of independent reaction zones respectively coated with different electrochemical mediators.
